(19) United States
(12) Patent Application Publication
(10) Pub. No.: US 2026/0328154 A1
(43) Pub. Date: Oct. 22, 2026

(54) Control Device and Control Method for Internal Combustion Engine

(71) Applicant: Hitachi Astemo, Ltd., Hitachinaka-shi, Ibaraki (JP)

(72) Inventors: Hiroto ISHIKAWA, Hitachinaka-shi, Ibaraki (JP); Shinya MATOHARA, Hitachinaka-shi, Ibaraki (JP)

(21) Appl. No.: 19/112,329

(22) PCT Filed: Nov. 30, 2022
(86) PCT No.: PCT/JP2022/044202

§ 371 Date: Mar. 17, 2025

(51) Int. Cl. F02D 41/24; F02D 41/26

(52) U.S. Cl. CPC F02D 41/2445; F02D 41/2438; F02D 41/2464; F02D 41/26; F02D 2200/04; F02D 2200/101; F02D 2200/50

(57) ABSTRACT

A control device 100 of an internal combustion engine that controls the internal combustion engine using a flow rate detection value of an air flow sensor that detects an intake air amount of the internal combustion engine, includes an operation control unit 120, a pulsation rate prediction unit 130, an allowable pulsation rate output unit 140, and a limited target value output unit 110. The operation control unit 120 controls the operation state of the internal combustion engine based on the control target value CTV of the internal combustion engine. The pulsation rate prediction unit 130 outputs a predicted pulsation rate PRe obtained by predicting the pulsation rate of the flow rate detection value based on the control target value CTV. The allowable pulsation rate output unit 140 outputs an allowable pulsation rate PRa based on the rotation speed ES as the operation state of the internal combustion engine. In a case where the predicted pulsation rate PRe exceeds the allowable pulsation rate PRa, the limited target value output unit 110 outputs a limited target value CTVr obtained by changing the control target value CTV so as to reduce the pulsation rate. In a case where the limited target value CTVr is input, the limited target value output unit 110 controls the operation state of the internal combustion engine based on the limited target value CTVr.

### TECHNICAL FIELD

The present disclosure relates to a control device and a control method for an internal combustion engine.

### BACKGROUND ART

Conventionally, an invention related to an engine control device that controls a spark ignition type internal combustion engine has been known. For example, a conventional engine control device described in PTL 1 below controls an internal combustion engine including a fuel injection device that supplies fuel to a cylinder and a throttle valve disposed in an intake passage.

The conventional engine control device includes a processor, an air flow sensor that is disposed in an intake passage on an upstream side of a throttle valve and detects an intake air flow rate, and a throttle position sensor that detects a throttle opening of the throttle valve. The fuel injection control executed by the processor includes a first fuel injection process and a second fuel injection process.

In the first fuel injection process, the fuel injection device is controlled so as to inject the amount of fuel corresponding to a first intake air amount based on the intake air flow rate detected by the air flow sensor. In the second fuel injection process, the fuel injection device is controlled so as to inject the amount of fuel corresponding to a second intake air amount based on the throttle opening detected by the throttle position sensor.

The processor selects the first fuel injection process in a case where a pulsation rate that is a fluctuation rate of pulsation of the intake air flow rate detected by the air flow sensor is equal to or less than a pulsation rate threshold, and selects the second fuel injection process in a case where the t is higher than the pulsation rate threshold. The pulsation rate threshold is smaller in a case where the temperature correlation value correlated with the temperature of the internal combustion engine is low than in a case where the temperature correlation value is high (PTL 1, paragraph 0008, Claim 1, Abstract, and the like).

### CITATION LIST

### Patent Literature

PTL 1: JP 2021-076040 A

### SUMMARY OF INVENTION

### Technical Problem

As described above, in the conventional engine control device, the second fuel injection process of injecting an amount of fuel corresponding to the second intake air amount based on the throttle opening is selected in a case where the pulsation rate of the intake air flow rate is higher than the pulsation rate threshold. Even in a case where the second fuel injection process is selected in the conventional engine control device, control has been studied in which a pulsation correction value for correcting the flow rate detection value of the intake air by the air flow sensor is obtained, and fuel of an amount corresponding to the corrected flow rate detection value is injected.

The pulsation correction value is determined as follows, for example. An internal combustion engine is operated under a reference condition of a predetermined temperature range, an intake air amount is detected by an air flow sensor when pulsation of intake air occurs, and the intake air amount is calculated based on an operation state such as a rotation speed, a throttle opening, and an exhaust component of the internal combustion engine. Then, the pulsation correction value is determined so as to match the intake air amount detected by the air flow sensor with the intake air amount calculated based on the operation state.

However, for example, at a cryogenic condition deviating from the reference condition, the resonance frequency of the intake air decreases, and the peak of the pulsation rate of the intake air shifts to a low rotation speed side of the internal combustion engine. As a result, the relationship between the rotation speed of the internal combustion engine and the pulsation rate of the intake air deviates from the range in which the pulsation correction value is determined, the flow rate detection value of the air flow sensor cannot be corrected, and the operation performance and the exhaust component of the internal combustion engine may deteriorate.

The present disclosure provides a control device and a control method for an internal combustion engine capable of preventing a relationship between a rotation speed of the internal combustion engine and a pulsation rate of intake air from deviating from a range in which the pulsation correction value is determined and preventing deterioration of operation performance and an exhaust component of the internal combustion engine.

### Solution to Problem

According to one aspect of the present disclosure, there is provided a control device of an internal combustion engine that controls the internal combustion engine using a flow rate detection value of an air flow sensor that detects an intake air amount of the internal combustion engine, the control device including: an operation control unit that controls an operation state of the internal combustion engine based on a control target value of the internal combustion engine; a pulsation rate prediction unit that outputs a predicted pulsation rate obtained by predicting a pulsation rate of the flow rate detection value based on the control target value; an allowable pulsation rate output unit that outputs an allowable pulsation rate that is a maximum value of the allowable pulsation rate based on the operation state of the internal combustion engine; and a limited target value output unit that outputs a limited target value obtained by changing the control target value so as to reduce the pulsation rate in a case where the predicted pulsation rate exceeds the allowable pulsation rate. The operation control unit controls the operation state of the internal combustion engine based on the limited target value in a case where the limited target value is input.

### Advantageous Effects of Invention

According to one aspect of the present disclosure, it is possible to provide a control device of an internal combustion engine capable of preventing a relationship between a rotation speed of the internal combustion engine and a pulsation rate of intake air from deviating from a range in which the pulsation correction value is determined and preventing deterioration of operation performance and an exhaust component of the internal combustion engine.

### BRIEF DESCRIPTION OF DRAWINGS

FIG. 1 is a schematic diagram illustrating a first embodiment of a control device of an internal combustion engine according to the present disclosure.

FIG. 2 is a functional block diagram of the control device of the internal combustion engine of FIG. 1.

FIG. 3 is a block diagram illustrating details of a pulsation rate prediction unit and an allowable pulsation rate output unit of FIG. 2.

FIG. 4 is a flowchart illustrating a control method using the control device of the internal combustion engine of FIG. 2.

FIG. 5 is a graph showing a relationship between a rotation speed of an internal combustion engine and a pulsation rate of a flow rate detection value.

FIG. 6 is a graph showing a relationship between a rotation speed of an internal combustion engine and a pulsation rate of a flow rate detection value.

FIG. 7 is a graph showing a relationship between a rotation speed of an internal combustion engine and a pulsation rate of a flow rate detection value.

FIG. 8 is a flowchart illustrating a pre-step of the control method for the internal combustion engine of FIG. 4.

FIG. 9 is a block diagram illustrating a second embodiment of a control device of an internal combustion engine according to the present disclosure.

### DESCRIPTION OF EMBODIMENTS

Hereinafter, embodiments of a control device and a control method for an internal combustion engine according to the present disclosure will be described with reference to the drawings.

### First Embodiment

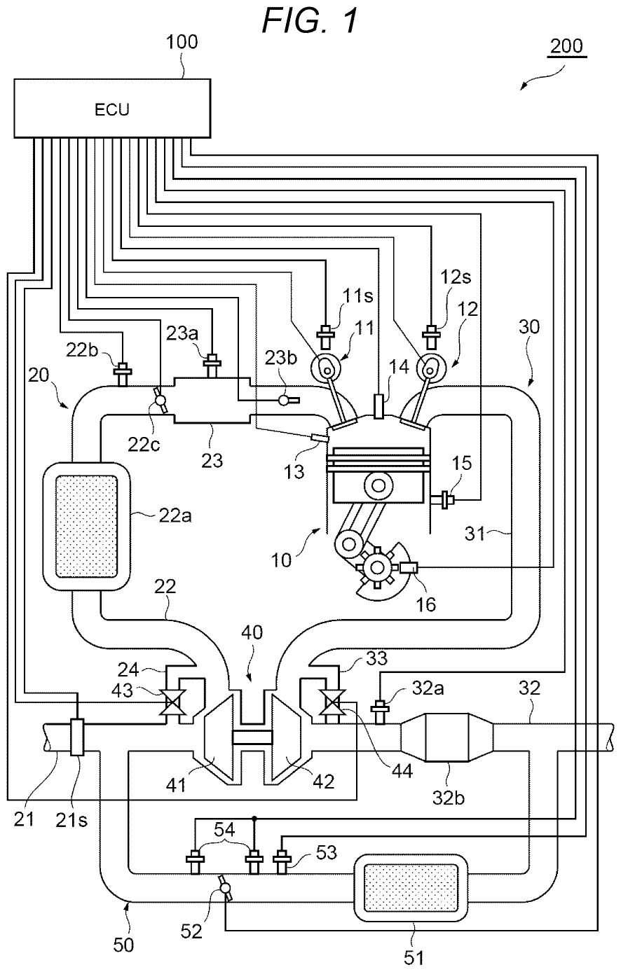

FIG. 1 is a schematic diagram of an engine system 200 which is an embodiment of a control device of an internal combustion engine of the present disclosure. The engine system 200 includes, for example, an internal combustion engine 10, an intake flow path 20, an exhaust flow path 30, a turbocharger 40, an exhausted gas recirculation (EGR) flow path 50, and a control device 100 of the internal combustion engine. The control device 100 of the internal combustion engine of the present embodiment is, for example, an electronic control unit (ECU) including a central processing unit (CPU) and a storage device (ROM, RAM, etc.).

The internal combustion engine 10 includes, for example, an intake valve 11, an exhaust valve 12, a fuel injection valve 13, an ignition plug 14, a knock sensor 15, and a crank angle sensor 16. The internal combustion engine 10 is connected to the intake flow path 20 and the exhaust flow path 30. Each of the intake valve 11 and the exhaust valve 12 has a variable valve mechanism. The variable valve mechanism includes sensors 11s and 12s that detect open/close phases of the intake valve 11 and the exhaust valve 12, and has a configuration in which the phases of the intake valve 11 and the exhaust valve 12 are continuously variable.

The fuel injection valve 13 is, for example, a direct injection valve that directly injects fuel into a cylinder of the internal combustion engine 10. The fuel injection valve 13 may be a port injection type injection valve that injects fuel to an intake port. The electrode portion of the ignition plug 14 is exposed in the cylinder of the internal combustion engine 10, and the combustible mixture is ignited by a spark. The knock sensor 15 is provided in a cylinder block of the internal combustion engine 10, and detects the presence or absence of knock generated in the combustion chamber. The crank angle sensor 16 is provided on a crankshaft of the internal combustion engine 10, and outputs a signal corresponding to a rotation angle of the crankshaft as a signal indicating a rotation speed of the crankshaft to the control device 100 of the internal combustion engine in each combustion cycle.

The intake flow path 20 includes, for example, an upstream portion 21, a midstream portion 22, a downstream portion 23, and a bypass portion 24. The upstream portion 21 is a flow path connecting an air cleaner (not illustrated) and the turbocharger 40. The midstream portion 22 is a flow path connecting the turbocharger 40 and the downstream portion 23 of the intake flow path 20. The downstream portion 23 is an intake manifold connected to the internal combustion engine 10. The bypass portion 24 is a flow path connecting the upstream portion 21 and the midstream portion 22.

The upstream portion 21 of the intake flow path 20 is provided with, for example, an air flow sensor 21s that detects a flow rate of intake air flowing through the intake flow path 20. The air flow sensor 21s includes, for example, a temperature sensor, a pressure sensor, and a humidity sensor in addition to the flow rate sensor, and is configured as a physical quantity detection device capable of detecting the flow rate, temperature, pressure, and humidity of the intake air.

The air flow sensor 21s includes, for example, a thermal flow sensor, and includes a bypass passage as a sub-passage that bypasses the air flowing through the intake flow path 20 as a main passage. The thermal flow sensor is disposed in the bypass passage, and detects a temperature difference generated on the upstream side and the downstream side of a heater due to the flow of air by a bridge circuit including a resistance temperature detector, thereby outputting a voltage signal corresponding to the flow rate of air flowing through the bypass flow path.

The midstream portion 22 of the intake flow path 20 is provided with, for example, an intercooler 22a, a supercharging temperature sensor 22b, and a throttle valve 22c. The intercooler 22a cools the air whose temperature has risen due to adiabatic compression by a compressor 41 of the turbocharger 40 to lower the temperature. The supercharging temperature sensor 22b is disposed downstream of the intercooler 22a and measures the temperature of the air cooled by the intercooler 22a.

The throttle valve 22c is provided downstream of the supercharging temperature sensor 22b, throttles the intake flow path 20, and controls the amount of air flowing into the combustion chamber of the internal combustion engine 10. The throttle valve 22c is configured by, for example, an electronically controlled butterfly valve capable of controlling a valve opening independently of a depression amount of an accelerator pedal by a driver.

For example, a supercharging pressure sensor 23a and a flow enhancing valve 23b are provided in the downstream portion 23 of the intake flow path 20. The supercharging pressure sensor 23a is disposed on the downstream side of the throttle valve 22c provided in the midstream portion 22. The flow enhancing valve 23b increases turbulence generated in the flow inside the combustion chamber of the internal combustion engine 10 by generating a drift in the intake air.

The exhaust flow path 30 includes, for example, an upstream portion 31, a downstream portion 32, and a bypass portion 33. The upstream portion 31 is an exhaust manifold that connects the internal combustion engine 10 and the turbocharger 40. The downstream portion 32 is a flow path connecting the turbocharger 40 and a muffler (not illustrated). The bypass portion 33 is a flow path connecting the upstream portion 31 and the downstream portion 32 of the exhaust flow path 30. For example, an air-fuel ratio sensor 32a and an exhaust purification catalyst 32b are provided in the downstream portion 32 of the exhaust flow path 30.

The air-fuel ratio sensor 32a is provided downstream of a turbine 42 of the turbocharger 40, and outputs a signal indicating the detected oxygen concentration, that is, the air-fuel ratio, to an internal combustion engine control device 60. The exhaust purification catalyst 32b is provided downstream of the air-fuel ratio sensor 32a, and purifies harmful exhaust gas components such as carbon monoxide, nitrogen compounds, and unburned hydrocarbon in the exhaust gas by a catalytic reaction.

The turbocharger 40 includes a compressor 41 and a turbine 42, and includes, for example, an air bypass valve 43 provided in the bypass portion 24 of the intake flow path 20 and a wastegate valve 44 provided in the bypass portion 33 of the exhaust flow path 30. The compressor 41 includes a compressor blade, the upstream portion 21 of the intake flow path 20 is connected to an upstream side of the compressor blade, and the midstream portion 22 of the intake flow path 20 is connected to a downstream side of the compressor blade.

The turbine 42 includes a turbine blade connected to the compressor blade, the upstream portion 31 of the exhaust flow path 30 is connected to an upstream side of the turbine blade, and the downstream portion 32 of the exhaust flow path 30 is connected to a downstream side of the turbine blade. The turbine 42 converts energy of the exhaust gas flowing through the exhaust flow path 30 into rotational energy by the turbine blade. The compressor 41 compresses air flowing through the intake flow path 20 by rotation of compressor blades.

The air bypass valve 43 prevents an excessive increase in pressure from the downstream of the compressor 41 to the upstream of the throttle valve 22c under the control of the control device 100 of the internal combustion engine. In a case where the throttle valve 22c is rapidly closed in the supercharged state, the air bypass valve 43 is opened according to the control of the control device 100 of the internal combustion engine, SO that the compressed intake air downstream of the compressor 41 flows back to the upstream of the compressor 41 through the bypass portion 24 of the intake flow path 20. As a result, the supercharging pressure can be reduced.

The wastegate valve 44 is an electric valve whose valve opening can be freely controlled with respect to supercharging pressure by control of the control device 100 of the internal combustion engine. The opening of the wastegate valve 44 is adjusted by the control device 100 of the internal combustion engine based on the supercharging pressure detected by the supercharging pressure sensor 23a provided in the downstream portion 23 of the intake flow path 20. Since a part of the exhaust gas passes through the bypass portion 33 of the exhaust flow path 30, the work given to the turbine 42 by the exhaust gas can be reduced, and as a result, the supercharging pressure can be maintained at the target pressure.

The EGR flow path 50 has one end connected to the downstream portion 32 of the exhaust flow path 30 and the other end connected to the upstream portion 21 of the intake flow path 20, and splits the exhaust gas from the downstream of the exhaust purification catalyst 32b and returns the exhaust gas to the upstream of the compressor 41. The EGR flow path 50 is provided with, for example, an EGR cooler 51, an EGR valve 52, a temperature sensor 53, and a differential pressure sensor 54.

The EGR cooler 51 cools the exhaust gas. The EGR valve 52 is provided downstream of the EGR cooler 51 and controls the flow rate of the exhaust gas. The temperature sensor 53 detects the temperature of the exhaust gas in the upstream portion of the EGR valve 52. The differential pressure sensor 54 detects a differential pressure between the upstream side and the downstream side of the EGR valve 52.

The control device 100 of the internal combustion engine controls each unit of the engine system 200 and executes various data processing. The control device 100 of the internal combustion engine is connected to the above-described various sensors and various actuators. The various actuators drive, for example, the throttle valve 22c, the fuel injection valve 13, the intake valve 11 with a variable valve mechanism, the exhaust valve 12, and the EGR valve 52.

The control device 100 of the internal combustion engine controls the operation of such various actuators. In addition, the control device 100 of the internal combustion engine detects the operation state of the internal combustion engine 10 based on signals input from various sensors, and ignites the ignition plug 14 at timing determined according to the operation state.

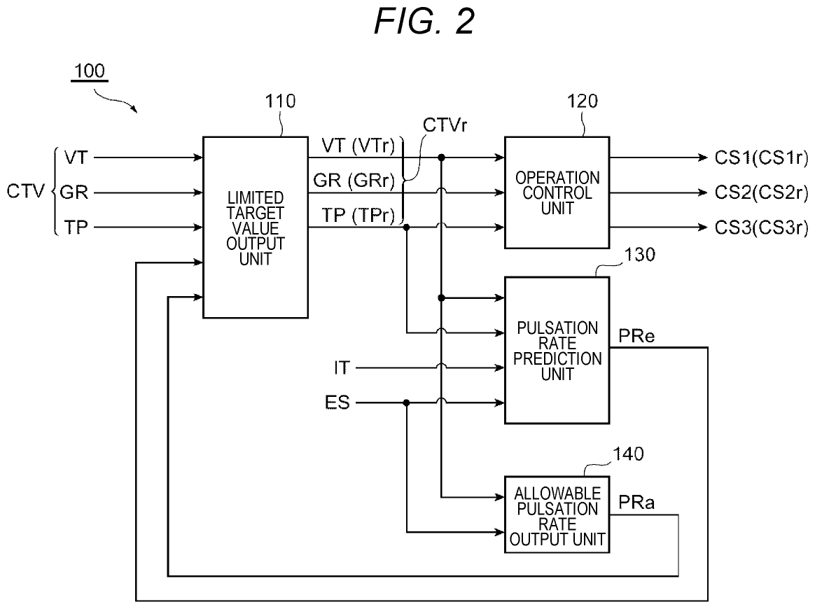

FIG. 2 is a functional block diagram for explaining a part of the functions of the control device 100 of the internal combustion engine illustrated in FIG. 1. The control device 100 of the internal combustion engine of the present embodiment includes a limited target value output unit 110, an operation control unit 120, a pulsation rate prediction unit 130, and an allowable pulsation rate output unit 140. Each unit of the control device 100 of the internal combustion engine represents, for example, each function of the control device 100 of the internal combustion engine realized by executing a program stored in a memory by the CPU.

For example, when a driver of a vehicle on which the control device 100 of the internal combustion engine is mounted puts a shift lever into a drive and presses an accelerator pedal, an operation amount of the accelerator pedal is detected by an accelerator position sensor and is input to the control device 100 of the internal combustion engine. Alternatively, information on the travel route from the current location to the destination is input to the control device 100 of the internal combustion engine mounted on the vehicle, and automatic driving of the vehicle is started.

Then, the control device 100 of the internal combustion engine generates a control target value CTV of the internal combustion engine 10 according to, for example, the speed and target speed of the vehicle, the operation amount of the accelerator pedal, the flow rate detection value of the air flow Sensor 21s, the shift position, and the like. As illustrated in FIG. 2, the generated control target value CTV is input to, for example, the limited target value output unit 110.

Although not particularly limited, the control target value CTV of the internal combustion engine 10 includes, for example, a target valve timing VT, a target gear ratio GR, and a target throttle opening TP. The target valve timing VT is, for example, a target value of the opening/closing timing of the intake valve 11 and the exhaust valve 12 of the internal combustion engine 10. The target gear ratio GR is, for example, a target value of a gear ratio of an automatic transmission of a vehicle on which the internal combustion engine 10 is mounted. The target throttle opening TP is, for example, a target value of the opening of the throttle valve 22c that controls the intake air amount flowing through the intake flow path 20.

For example, in a case where a predetermined condition is satisfied, the limited target value output unit 110 changes the input control target value CTV and outputs a limited target value CTVr. In a case where the predetermined condition is not satisfied, the limited target value output unit 110 outputs the input control target value CTV as it is to the operation control unit 120. The limited target value CTVr includes, for example, a limited valve timing VTr, a limited gear ratio GRr, and a limited throttle opening TPr. Details of the predetermined condition and the limited target value CTVr determined by the limited target value output unit 110 will be described later.

For example, the operation control unit 120 outputs control signals CS1, CS2, and CS3 for controlling the operation state of the internal combustion engine 10 based on the control target value CTV of the internal combustion engine 10 input from the limited target value output unit 110. More specifically, the control signals CS1, CS2, and CS3 are, for example, control signals for an actuator that opens and closes the intake valve 11 and the exhaust valve 12, an automatic transmission, and an electronically controlled throttle valve 22c.

That is, the operation control unit 120 controls the operation state of the internal combustion engine 10 by controlling, for example, actuators that operate the intake valve 11, the exhaust valve 12, the automatic transmission, and the throttle valve 22c based on the control target value CTV of the internal combustion engine 10. Here, the operation state of the internal combustion engine 10 includes, for example, the rotation speed of the internal combustion engine 10.

The pulsation rate prediction unit 130 outputs a predicted pulsation rate PRe obtained by predicting the pulsation rate of the flow rate detection value of the air flow sensor 21s based on the control target value CTV of the internal combustion engine 10. Here, the pulsation rate is a ratio of the amplitude of the flow rate detection value to the average value of the flow rate detection value of the air flow sensor 21s. The pulsation rate is correlated with the rotation speed of the internal combustion engine 10 and the intake air temperature. For example, in a case where the intake air temperature is a normal temperature of about 25 [° C.] and the rotation speed of the internal combustion engine 10 is a low rotation speed of about 800 [rpm] to 1000 [rpm], the pulsation rate is about 100 [%].

The pulsation rate increases as the rotation speed of the internal combustion engine 10 increases. For example, in a case where the intake air temperature is a normal temperature of about 25 [° C.], the pulsation rate reaches a peak exceeding 400 [%] when the rotation speed is about 1600 [rpm], but gradually decreases as the rotation speed further increases. In addition, the peak of the pulsation rate shifts to the low rotation side of the internal combustion engine 10 when the intake air temperature decreases, and shifts to the high rotation side of the internal combustion engine 10 when the intake air temperature increases. When the intake air temperature decreases, the peak of the pulsation rate also tends to increase.

The allowable pulsation rate output unit 140 outputs an allowable pulsation rate PRa which is the maximum value of the allowable pulsation rate based on the operation state of the internal combustion engine 10. More specifically, the allowable pulsation rate output unit 140 outputs the allowable pulsation rate PRa based on, for example, the rotation speed ES of the internal combustion engine 10.

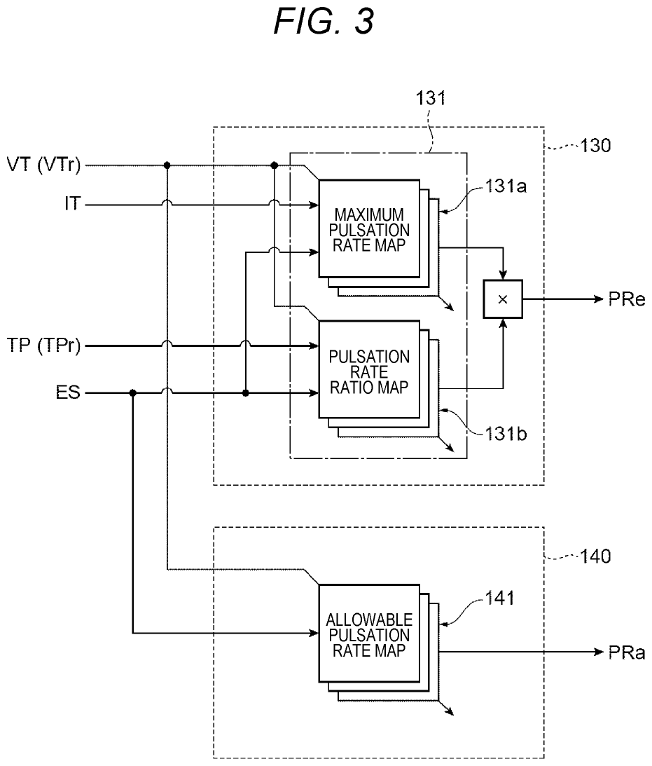

FIG. 3 is a block diagram illustrating details of the pulsation rate prediction unit 130 and the allowable pulsation rate output unit 140 of the control device 100 of the internal combustion engine of FIG. 2. The pulsation rate prediction unit 130 is provided with a pulsation rate map 131 in which the relationship between the control target value CTV of the internal combustion engine 10 and the pulsation rate of the flow rate detection value of the air flow sensor 21s under the reference condition of a predetermined temperature range is defined. The pulsation rate map 131 includes, for example, a maximum pulsation rate map 131a and a pulsation rate ratio map 131b.

The maximum pulsation rate map 131a is, for example, a map defining the relationship between a rotation speed ES of the internal combustion engine 10 and the maximum value of the pulsation rate of the flow rate detection value of the air flow sensor 21s. More specifically, the maximum pulsation rate map 131a defines, for example, the relationship between the rotation speed ES of the internal combustion engine 10, the temperature of the intake air flowing through the intake flow path 20, that is, an intake air temperature IT, and the maximum value of the pulsation rate. The maximum pulsation rate map 131a is defined for each target valve timing VT, for example.

For example, when the target valve timing VT and the rotation speed ES of the internal combustion engine 10 are input, the maximum pulsation rate map 131a outputs the maximum pulsation rate which is the maximum value of the pulsation rate at the rotation speed ES. More specifically, when the intake air temperature IT, the target valve timing VT, and the rotation speed ES are input, for example, the maximum pulsation rate map 131a outputs the maximum pulsation rate in a case where the conditions are satisfied.

The pulsation rate ratio map 131b is, for example, a map defining a relationship between the rotation speed ES and the target throttle opening TP of the internal combustion engine 10, and the ratio of the pulsation rate to the maximum value, that is, the pulsation rate ratio. The pulsation rate ratio map 131b is defined for each target valve timing VT, for example, similarly to the maximum pulsation rate map 131a. When the rotation speed ES and the target throttle opening TP are input, the pulsation rate ratio map 131b outputs the pulsation rate ratio in a case where the conditions are satisfied.

The pulsation rate map 131 estimates the pulsation rate at the input rotation speed ES by, for example, multiplying the maximum pulsation rate output from the maximum pulsation rate map 131a by the pulsation rate ratio output from the pulsation rate ratio map 131b. That is, the pulsation rate map 131 outputs the predicted pulsation rate PRe, which is an estimated value of the pulsation rate of the flow rate detection value by the air flow sensor 21s, based on, for example, the intake air temperature IT, the target valve timing VT, and the rotation speed ES of the internal combustion engine 10.

As described above, the pulsation rate prediction unit 130 outputs the predicted pulsation rate PRe based on, for example, the rotation speed ES of the internal combustion engine 10 and the intake air temperature IT in addition to the control target value CTV including the target throttle opening TP. Here, the target throttle opening TP is the opening of the throttle valve 22c that controls the intake air amount. The pulsation rate prediction unit 130 outputs the predicted pulsation rate PRe based on the control target value CTV including the target valve timing VT, for example. Here, the target valve timing VT is opening/closing timing of the intake valve 11 and the exhaust valve 12 of the internal combustion engine 10. For example, the pulsation rate prediction unit 130 may output the predicted pulsation rate PRe based on the control target value CTV including the target supercharging pressure of the turbocharger 40 provided in the exhaust flow path 30 and the intake flow path 20 of the internal combustion engine 10.

The allowable pulsation rate output unit 140 is provided with, for example, an allowable pulsation rate map 141 indicating the relationship between the operation state of the internal combustion engine 10 and the allowable pulsation rate PRa which is the maximum value of the allowable pulsation rate. More specifically, the allowable pulsation rate output unit 140 is provided with, for example, an allowable pulsation rate map 141 indicating the relationship between the rotation speed ES of the internal combustion engine 10 and the allowable pulsation rate PRa. The allowable pulsation rate map 141 is defined for each target valve timing VT, for example. The allowable pulsation rate map 141 outputs the allowable pulsation rate PRa, for example, when the target valve timing VT and the rotation speed ES, which is the operation state of the internal combustion engine 10, are input.

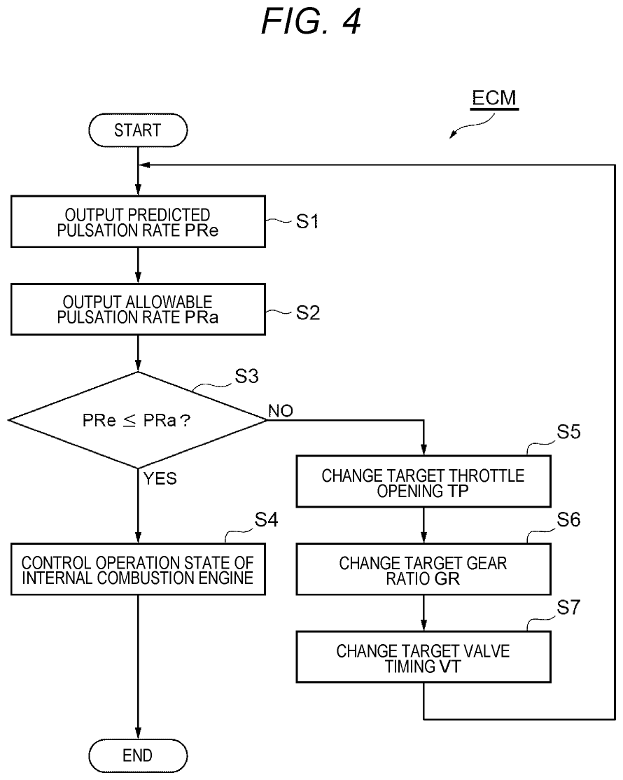

Hereinafter, a control method for the internal combustion engine using the control device 100 of the internal combustion engine of the present embodiment will be described with reference to FIG. 4. FIG. 4 is a flowchart illustrating a control method ECM for an internal combustion engine using the internal combustion engine control device 100 of FIGS. 2 and 3. When starting the control method ECM for the internal combustion engine illustrated in FIG. 4, the control device 100 of the internal combustion engine first executes a pulsation rate prediction step S1 of outputting the predicted pulsation rate PRe based on the control target value CTV of the internal combustion engine 10.

In this step S1, for example, as illustrated in FIG. 2, the limited target value output unit 110 outputs the input control target value CTV to the operation control unit 120 as it is. The pulsation rate prediction unit 130 outputs a predicted pulsation rate PRe in which the pulsation rate is predicted based on the control target value CTV input from the limited target value output unit 110 using, for example, the pulsation rate map 131 illustrated in FIG. 3.

More specifically, as illustrated in FIG. 3, for example, the target valve timing VT and the target throttle opening TP, the intake air temperature IT detected by the air flow sensor 21s, and the rotation speed ES of the internal combustion engine 10 based on the detection result of the crank angle sensor 16 are input to the pulsation rate map 131. As a result, the pulsation rate map 131 outputs a predicted pulsation rate PRe which is a prediction result of the pulsation rate of the flow rate detection value by the air flow sensor 21s in a case where these conditions are satisfied.

Next, as illustrated in FIG. 4, the control device 100 of the internal combustion engine executes an allowable pulsation rate output step S2 of outputting the allowable pulsation rate PRa. In this step S2, the allowable pulsation rate output unit 140 outputs the allowable pulsation rate PRa based on the operation state of the internal combustion engine 10 using, for example, the allowable pulsation rate map 141 illustrated in FIG. 3. More specifically, as illustrated in FIG. 3, for example, the rotation speed ES of the internal combustion engine 10 and the target valve timing VT are input to the allowable pulsation rate map 141.

As a result, the allowable pulsation rate map 141 outputs an allowable pulsation rate PRa which is an allowable maximum value of the pulsation rate of the flow rate detection value by the air flow sensor 21s in a case where these conditions are satisfied. In steps S1 and S2, the predicted pulsation rate PRe and the allowable pulsation rate PRa output from the pulsation rate prediction unit 130 and the allowable pulsation rate output unit 140 are input to the limited target value output unit 110, for example, as illustrated in FIG. 2.

Next, as illustrated in FIG. 4, the control device 100 of the internal combustion engine executes a comparison step S3 of comparing the predicted pulsation rate PRe and the allowable pulsation rate PRa. In this step S3, the limited target value output unit 110 compares, for example, the predicted pulsation rate PRe with the allowable pulsation rate PRa input in steps S1 and S2. In this step S3, when determining that the predicted pulsation rate PRe is equal to or less than the allowable pulsation rate PRa (YES), the limited target value output unit 110 outputs the control target value CTV input to the limited target value output unit 110 to the operation control unit 120 as it is.

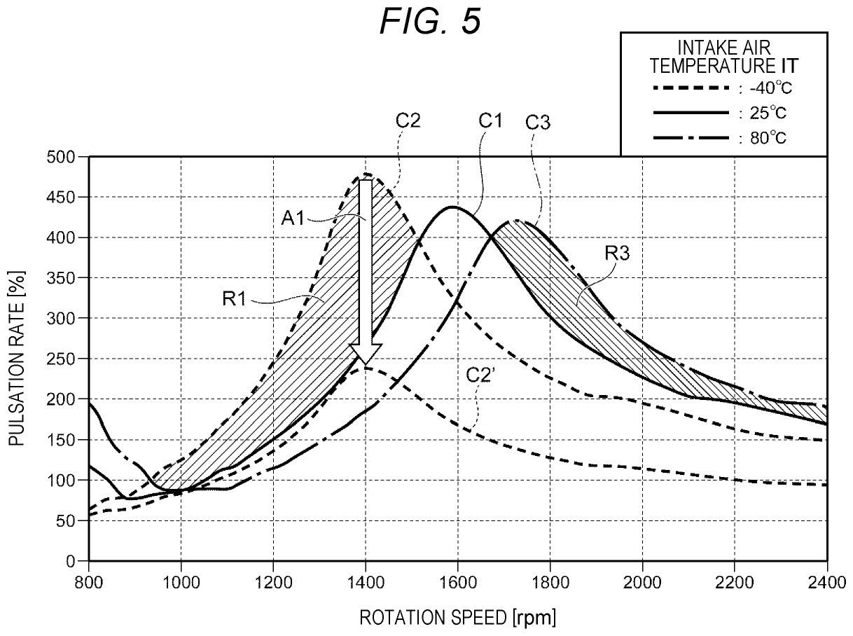

FIGS. 5 to 7 are graphs illustrating the relationship between the rotation speed ES of the internal combustion engine 10 and the pulsation rate of the flow rate detection value by the air flow sensor 21s. In FIGS. 5 to 7, a curve C1 indicated by a solid line indicates the relationship between the rotation speed ES and the pulsation rate in a case where the target throttle opening TP is fully opened and the intake air temperature IT is 25 [° C.] . The flow rate detection value by the air flow sensor 21s generates an error due to the influence of pulsation of the intake air flowing through the intake flow path 20, for example.

The pulsation correction value for correcting the error of the flow rate detection value of the air flow sensor 21s due to the pulsation of the intake air is determined, for example, by the following procedure. For example, the internal combustion engine 10 is operated while changing the rotation speed ES under a reference condition of a predetermined temperature range in which the intake air temperature IT becomes 25 [° C.]. Then, the flow rate of the intake air flowing through the intake flow path 20 is detected by the air flow sensor 21s, and is detected by a known method in which the influence of the pulsation of the intake air on the flow rate detection value is smaller than that of the air flow sensor 21s.

As a result, the relationship among the rotation speed ES of the internal combustion engine 10, the pulsation rate of the flow rate detection value by the air flow sensor 21s, and the error of the flow rate detection value by the air flow sensor 21s is obtained, and the pulsation correction value is determined so as to correct the error of the flow rate detection value. That is, as indicated by solid lines in FIGS. 5 to 7, the region above the curve C1 and the region below the curve C1 indicating the relationship between the rotation speed ES and the pulsation rate in a case where the target throttle opening TP is fully opened and the intake air temperature IT is 25° C. is a region where the pulsation correction value is determined and the flow rate detection value by the air flow sensor 21s is adapted.

A point on the solid curve C1 represents the allowable pulsation rate PRa for each rotation speed ES. Therefore, in a case where it is determined in the comparison step S3 of FIG. 4 that the predicted pulsation rate PRe is equal to or less than the allowable pulsation rate PRa (YES), the predicted pulsation rate PRe is in a region above or below the solid curve C1. As described above, this region is a region in which the pulsation correction value is determined and the flow rate detection value by the air flow sensor 21s is adapted, and is a region in which the flow rate of the air flowing through the intake flow path 20 can be accurately detected by the air flow sensor 21s.

Therefore, in a case where the determination result of step S3 is affirmative, in the operation control step S4 of FIG. 4, the limited target value output unit 110 illustrated in FIG. 2 outputs the input control target value CTV of the internal combustion engine 10 as it is to the operation control unit 120 without changing the control target value CTV. Then, the operation control unit 120 outputs the control signals CS1, CS2, and CS3 based on the control target value CTV of the internal combustion engine 10 to, for example, an actuator that opens and closes the intake valve 11 and the exhaust valve 12, an automatic transmission, and the electronically controlled throttle valve 22c.

As a result, the operation state of the internal combustion engine 10 is controlled on the basis of the control target value CTV. Furthermore, the control device 100 of the internal combustion engine calculates a new control target value CTV of the internal combustion engine 10 using, for example, an adapted flow rate detection value of an air flow sensor 21s that detects an intake air amount of the internal combustion engine 10. Thereafter, the control device 100 of the internal combustion engine terminates the control method ECM for the internal combustion engine illustrated in FIG. 4, and repeats the control method ECM at a predetermined cycle, for example.

On the other hand, for example, when the intake air temperature IT extremely decreases in a cryogenic environment or the like, the resonance frequency of the intake air decreases. As a result, the relationship between the rotation speed of the internal combustion engine 10 and the pulsation rate of the flow rate detection value of the air flow sensor 21s when the intake air temperature IT indicated by the solid curve C1 in FIG. 5 is 25 [° C.] and the target throttle opening TP is fully opened shifts to the low rotation speed side.

For example, the relationship between the rotation speed of the internal combustion engine 10 and the pulsation rate of the flow rate detection value of the air flow sensor 21s when the intake air temperature IT is −40 [° C.] and the target throttle opening TP is fully opened is indicated by a broken curve C2 in FIG. 5. Of the point on the curve C2 indicated by the broken line and the region below the point, the region on the upper side of the curve C1 indicated by the solid line exceeds the allowable pulsation rate PRa.

That is, a region R1 between the curve C2 indicated by the broken line and the curve C1 indicated by the solid line is a region where the pulsation correction value of the flow rate detection value of the air flow sensor 21s is not defined, and the error of the flow rate detection value cannot be corrected. For example, it is assumed that the intake air temperature IT becomes a low temperature of −40 [° C.] and the limited target value output unit 110 determines that the predicted pulsation rate PRe exceeds the allowable pulsation rate PRa (NO) in step S3 illustrated in FIG. 4.

Then, as illustrated in FIG. 2, the limited target value output unit 110 outputs the limited target value CTVr obtained by changing the control target value CTV so as to reduce the pulsation rate. More specifically, for example, as illustrated in FIG. 4, the limited target value output unit 110 executes step S5 of changing the target throttle opening TP. In this step S5, the limited target value output unit 110 outputs a limited throttle opening TPr obtained by reducing the target throttle opening TP instead of the target throttle opening TP illustrated in FIG. 2.

Next, the limited target value output unit 110 executes step S6 of changing the target gear ratio GR, for example, as illustrated in FIG. 4. In this step S6, the limited target value output unit 110 outputs the limited gear ratio GRr obtained by increasing or decreasing the target gear ratio GR so as to decrease the predicted pulsation rate PRe instead of the target gear ratio GR illustrated in FIG. 2.

More specifically, in a case where the intake air temperature IT decreases and the solid curve C1 illustrated in FIG. 5 is shifted to the low rotation speed side as indicated by the broken curve C2, the limited gear ratio GRr is output which is shifted down to increase the rotation speed ES of the internal combustion engine 10. Conversely, in a case where the intake air temperature IT rises and the solid curve C1 illustrated in FIG. 5 shifts to the high rotation speed side as indicated by the curve C3 indicated by the one-dot chain line, the shift-up is performed to output the limited gear ratio GRr for decreasing the rotation speed ES of the internal combustion engine 10.

Next, the limited target value output unit 110 executes step S7 of changing the target valve timing VT, for example, as illustrated in FIG. 4. In this step S7, instead of the target valve timing VT illustrated in FIG. 2, the limited target value output unit 110 outputs a limited valve timing VTr that decreases the blowback from the combustion chamber to the intake flow path 20 than the target valve timing VT in the compression step of the internal combustion engine 10.

Thereafter, in step S1 illustrated in FIG. 4, as illustrated in FIGS. 2 and 3, the limited valve timing VTr and the limited throttle opening TPr, which are the limited target value CTVr, are input to the pulsation rate prediction unit 130. In this case, the pulsation rate prediction unit 130 outputs the predicted pulsation rate PRe based on the limited valve timing VTr and the limited throttle opening TPr which are the limited target value CTVr.

In addition, in the next step S2, as illustrated in FIGS. 2 and 3, the allowable pulsation rate output unit 140 outputs the allowable pulsation rate PRa with the limited valve timing VTr that is the limited target value CTVr as an input instead of the target valve timing VT that is the control target value CTV.

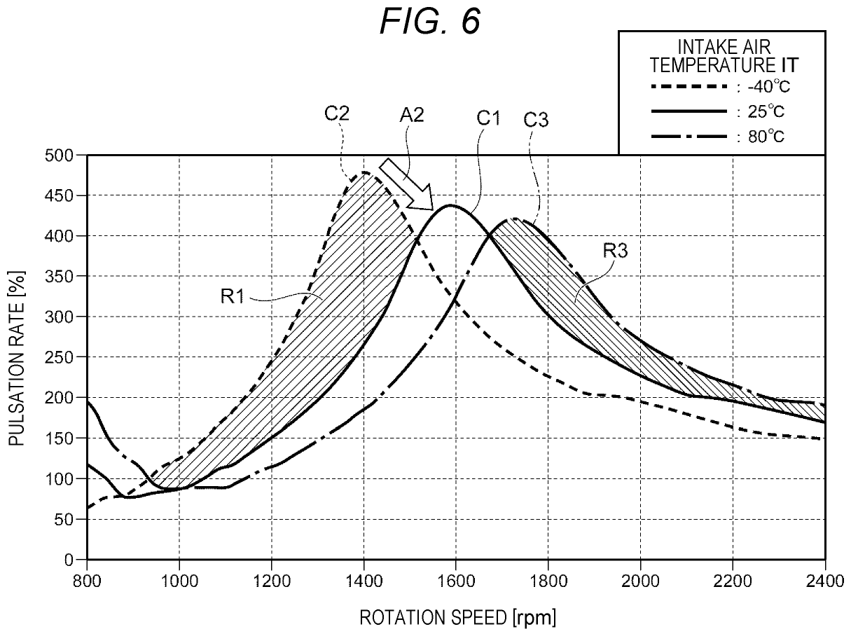

The predicted pulsation rate PRe based on the limited throttle opening TPr moves, for example, as indicated by an arrow Al in FIG. 5, from the region R1 above the solid curve C1 to a region above or below a broken curve C2′ having a peak below the solid curve C1. In addition, due to the change in the rotation speed ES of the internal combustion engine 10 based on the limited gear ratio GRr, the predicted pulsation rate PRe moves from the region R1 above the solid curve C1 to the region below the solid curve C1 as indicated by an arrow A2 in FIG. 6, for example.

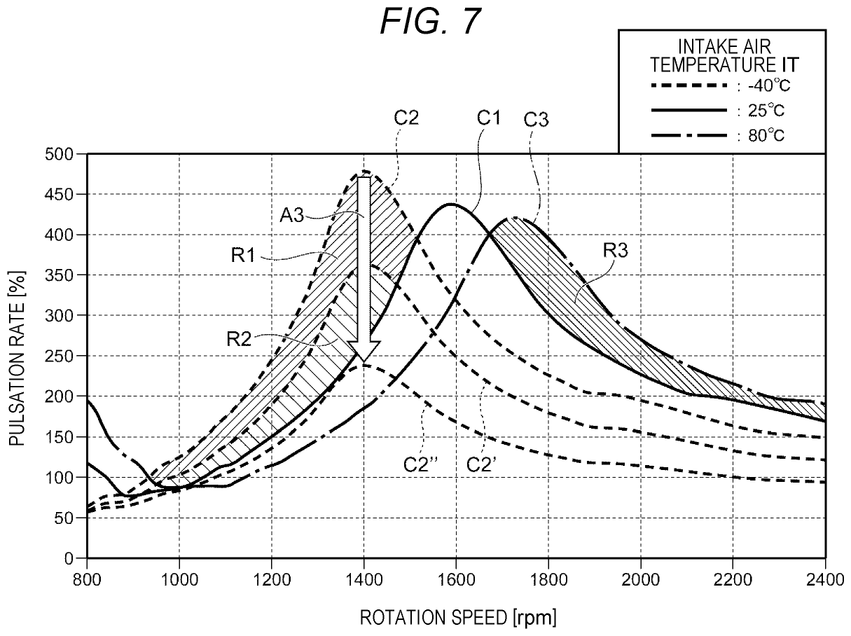

As illustrated in FIG. 7, the broken curve C2 based on the target valve timing VT moves to a region above or below the broken curve C2′ based on the limited valve timing VTr below the curve C2, for example, as indicated by an arrow A3. However, in a case where a part of the lower region of the curve C2′ is above the solid curve C1, the limited throttle opening TPr may be further used instead of the target throttle opening TP. As a result, as indicated by an arrow A3, the predicted pulsation rate PRe moves from a region R2 above the solid curve C1 to a region above or below a broken curve C2″ having a peak below the solid curve C1.

As illustrated in FIGS. 5 to 7, the predicted pulsation rate PRe moves to a region above the solid curve C1 or below the curve C1, so that the limited target value output unit 110 determines in step S3 illustrated in FIG. 4 that the predicted pulsation rate PRe is equal to or less than the allowable pulsation rate PRa (YES). Then, an operation control step S4 of controlling the operation state of the internal combustion engine 10 is executed by the operation control unit 120. In this step S4, when the limited target value CTVr is input, the operation control unit 120 controls the operation state of the internal combustion engine 10 based on the input limited target value CTVr.

On the other hand, when the limited target value output unit 110 determines in step S3 illustrated in FIG. 4 that the predicted pulsation rate PRe exceeds the allowable pulsation rate PRa (NO), steps S5 to S7 in which the limited target value output unit 110 outputs the limited target value CTVr are executed again. By repeating this, in step S3, the limited target value output unit 110 determines that the predicted pulsation rate PRe is equal to or less than the allowable pulsation rate PRa (YES), and step S4 of controlling the operation state of the internal combustion engine 10 is executed by the limited target value output unit 110.

As a result, as described above, the pulsation correction value is determined, and the internal combustion engine 10 is operated in the region below the solid curve C1 illustrated in FIG. 5 to which the flow rate detection value by the air flow Sensor 21s is adapted. Therefore, the air flow sensor 21s can accurately detect the flow rate of the air flowing through the intake flow path 20. As a result, the control device 100 of the internal combustion engine that controls the internal combustion engine 10 using the flow rate detection value by the air flow sensor 21s can prevent deterioration of the drivability and the exhaust component of the internal combustion engine 10.

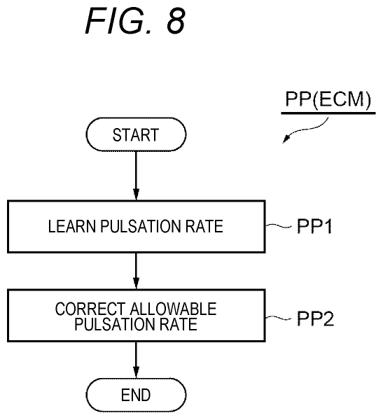

FIG. 8 is a flowchart illustrating a pre-step PP of the control method ECM for the internal combustion engine illustrated in FIG. 4. The pre-step PP of the control method ECM for the internal combustion engine includes, for example, a pulsation rate learning step PP1 and an allowable pulsation rate calibration step PP2. The pulsation rate learning step PP1 is a step of learning the relationship between the control target value CTV and the pulsation rate of the flow rate detection value of the air flow sensor 21s by machine learning under the reference condition of the internal combustion engine 10 described above, and generating the pulsation rate map 131 including, for example, the maximum pulsation rate map 131a and the pulsation rate ratio map 131b.

The allowable pulsation rate calibration step PP2 is a step of generating the allowable pulsation rate map 141 based on the pulsation rate map 131. More specifically, for example, the maximum pulsation rate when the throttle opening is fully opened for each rotation speed of the internal combustion engine 10 is derived from the maximum pulsation rate map 131a, and the maximum pulsation rate for each rotation speed of the internal combustion engine 10 is set as the allowable pulsation rate PRa.

Hereinafter, the operation of the control device 100 of the internal combustion engine and the control method ECM for the internal combustion engine of the present embodiment will be described.

The control device 100 of the internal combustion engine of the present embodiment controls the internal combustion engine 10 using a flow rate detection value of the air flow Sensor 21s that detects an intake air amount of the internal combustion engine 10. The control device 100 of the internal combustion engine includes an operation control unit 120, a pulsation rate prediction unit 130, an allowable pulsation rate output unit 140, and a limited target value output unit 110. The operation control unit 120 controls the operation state of the internal combustion engine 10 based on the control target value CTV of the internal combustion engine 10. The pulsation rate prediction unit 130 outputs a predicted pulsation rate PRe obtained by predicting the pulsation rate of the flow rate detection value by the air flow sensor 21s based on the control target value CTV. The allowable pulsation rate output unit 140 outputs an allowable pulsation rate PRa which is the maximum value of the allowable pulsation rate based on the operation state of the internal combustion engine 10. In a case where the predicted pulsation rate PRe exceeds the allowable pulsation rate PRa, the limited target value output unit 110 outputs a limited target value CTVr obtained by changing the control target value CTV so as to reduce the pulsation rate. In a case where the limited target value CTVr is input, the operation control unit 120 controls the operation state of the internal combustion engine 10 based on the limited target value CTVr.

With such a configuration, according to the control device 100 of the internal combustion engine of the present embodiment, the predicted pulsation rate PRe and the allowable pulsation rate PRa are obtained based on the control target value CTV of the internal combustion engine 10. Then, in a case where the predicted pulsation rate PRe exceeds the allowable pulsation rate PRa and enters the regions R1 and R3 above the solid curve C1 illustrated in FIGS. 5 to 7, the limited target value output unit 110 outputs the limited target value CTVr. As a result, the operation control unit 120 controls the operation state of the internal combustion engine 10 on the basis of the limited target value CTVr obtained by changing the control target value CTV so as to reduce the pulsation rate. As a result, as indicated by arrows Al and A2 in FIGS. 5 and 6, the relationship between the pulsation rate of the flow rate detection value of the air flow sensor 21s and the rotation speed of the internal combustion engine 10 moves to a region above or below the solid curve C1. A region above or below the solid curve C1 is a region where the pulsation correction value is determined and the flow rate detection value by the air flow sensor 21s is adapted. Therefore, the internal combustion engine 10 can be prevented from being operated in the regions R1 and R3 where the pulsation error cannot be corrected, and the internal combustion engine 10 can be controlled using the flow rate detection value of the air flow sensor 21s in which the pulsation error has been corrected. Therefore, according to the control device 100 of the internal combustion engine of the present embodiment, it is possible to prevent deterioration of the operation performance and the exhaust component of the internal combustion engine 10.

In addition, in the control device 100 of the internal combustion engine of the present embodiment, the control target value CTV includes a target throttle opening TP which is a target value of the opening of the throttle valve 22c for controlling the intake air amount. £ In addition, the limited target value CTVr includes a limited throttle opening TPr obtained by decreasing the target throttle opening TP.

With such a configuration, as illustrated in FIG. 5, for example, at a cryogenic temperature when the intake air temperature IT is −40 [° C.], the broken curve C2 indicating the relationship between the pulsation rate of the flow rate detection value of the air flow sensor 21s and the rotation speed of the internal combustion engine 10 in a case where the target throttle opening TP is fully opened can be moved to the broken curve C2′ below the solid curve C1. As a result, as described above, the internal combustion engine 10 can be prevented from being operated in the region R1 where the pulsation error cannot be corrected, and the internal combustion engine 10 can be controlled using the flow rate detection value of the air flow sensor 21s in which the pulsation error has been corrected.

Further, in the control device 100 of the internal combustion engine of the present embodiment, the control target value CTV includes a target valve timing VT which is a target value of opening/closing timing of the intake valve 11 and the exhaust valve 12 of the internal combustion engine 10. In addition, the limited target value CTVr includes a limited valve timing VTr that decreases the blowback from the combustion chamber to the intake flow path 20 below the control target value CTV in the compression step of the internal combustion engine 10.

With such a configuration, as illustrated in FIG. 7, for example, at a cryogenic temperature when the intake air temperature IT is −40 [° C.], the broken curve C2 indicating the relationship between the pulsation rate of the flow rate detection value of the air flow sensor 21s and the rotation speed of the internal combustion engine 10 in a case where the target throttle opening TP is fully opened can be moved to the broken curve C2′ on the lower side. Further, since the limited target value CTVr includes the limited throttle opening TPr, the broken curve C2′ can be moved to the broken curve C2″ below the solid curve C1. In this case, the difference between the target throttle opening TP and the limited throttle opening TPr can be reduced as compared with a case where the limited target value CTVr includes only the limited throttle opening TPr.

In addition, in the control device 100 of the internal combustion engine of the present embodiment, the control target value CTV includes the target gear ratio GR of the automatic transmission of the vehicle on which the internal combustion engine 10 is mounted. The limited target value CTVr includes the limited gear ratio GRr obtained by increasing or decreasing the target gear ratio GR so that the predicted pulsation rate PRe decreases.

With such a configuration, as illustrated in FIG. 6, for example, the rotation speed of the internal combustion engine 10 can be increased at a cryogenic temperature when the intake air temperature IT is −40 [° C.]. As a result, the point in the region R1 above the solid curve C1 can be moved to the lower side of the solid curve C1 as indicated by the arrow A2. As a result, as described above, the internal combustion engine 10 can be prevented from being operated in the region R1 where the pulsation error cannot be corrected, and the internal combustion engine 10 can be controlled using the flow rate detection value of the air flow sensor 21s in which the pulsation error has been corrected.

Further, in the control device 100 of the internal combustion engine of the present embodiment, the pulsation rate prediction unit 130 outputs the predicted pulsation rate PRe based on the rotation speed ES of the internal combustion engine 10 and the intake air temperature IT in addition to the control target value CTV including the opening of the throttle valve 22c that controls the intake air amount. With such a configuration, the pulsation rate prediction unit 130 can output a more accurate predicted pulsation rate PRe close to the actual pulsation rate.

In the control device 100 of the internal combustion engine of the present embodiment, the pulsation rate prediction unit 130 outputs the predicted pulsation rate PRe based on the control target value CTV including the opening/closing timing of the intake valve 11 and the exhaust valve 12 of the internal combustion engine 10. With such a configuration, the pulsation rate prediction unit 130 can output a more accurate predicted pulsation rate PRe close to the actual pulsation rate.

In addition, in the control device 100 of the internal combustion engine of the present embodiment, the pulsation rate prediction unit 130 can output the predicted pulsation rate PRe based on the control target value CTV including the target supercharging pressure of the turbocharger 40 provided in the intake flow path 20 and the exhaust flow path 30 of the internal combustion engine 10. With such a configuration, the pulsation rate prediction unit 130 can output a more accurate predicted pulsation rate PRe close to the actual pulsation rate.

Further, in the control device 100 of the internal combustion engine of the present embodiment, in a case where the limited target value CTVr is input, the pulsation rate prediction unit 130 outputs the predicted pulsation rate PRe based on the limited target value CTVr. With such a configuration, the predicted pulsation rate PRe can be made equal to or less than the allowable pulsation rate PRa by repeating steps S1 to S7 illustrated in FIG. 4.

In addition, the control method ECM for the internal combustion engine of the present embodiment is a control method for the internal combustion engine 10 using a flow rate detection value of the air flow sensor 21s that detects an intake air amount of the internal combustion engine 10. The control method ECM for the internal combustion engine includes an operation control step S4, a pulsation rate prediction step S1, an allowable pulsation rate output step S2, and limited target value output steps S5 to S7. The operation control step S4 is a step of controlling the operation state of the internal combustion engine 10 based on the control target value CTV of the internal combustion engine 10. The allowable pulsation rate output step S2 is a step of outputting the predicted pulsation rate PRe in which the pulsation rate is predicted based on the control target value CTV using the pulsation rate map 131 in which the relationship between the control target value CTV of the internal combustion engine 10 and the pulsation rate of the flow rate detection value of the air flow sensor 21s under the reference condition of a predetermined temperature range is defined. The allowable pulsation rate output step S2 is a step of outputting the allowable pulsation rate PRa based on the operation state of the internal combustion engine 10 using the allowable pulsation rate map 141 indicating the relationship between the operation state of the internal combustion engine 10 and the allowable pulsation rate PRa which is the maximum value of the allowable pulsation rate. The limited target value output steps S5 to S7 are steps of outputting the limited target value CTVr in which the control target value CTV is changed so as to reduce the pulsation rate in a case where the predicted pulsation rate PRe exceeds the allowable pulsation rate PRa. The control method ECM for the internal combustion engine of the present embodiment controls the operation state of the internal combustion engine 10 based on the limited target value CTVr in a case where the limited target value CTVr is input in the operation control step S4.

With such a configuration, according to the control method ECM for the internal combustion engine of the present embodiment, the predicted pulsation rate PRe and the allowable pulsation rate PRa are obtained based on the control target value CTV of the internal combustion engine 10. Then, in a case where the predicted pulsation rate PRe exceeds the allowable pulsation rate PRa and enters the regions R1 and R3 above the solid curve C1 illustrated in FIGS. 5 to 7, the limited target value CTVr can be output. As a result, the operation state of the internal combustion engine 10 is controlled on the basis of the limited target value CTVr obtained by changing the control target value CTV so as to reduce the pulsation rate. As a result, as indicated by arrows Al and A2 in FIGS. 5 and 6, the relationship between the pulsation rate of the flow rate detection value of the air flow sensor 21s and the rotation speed of the internal combustion engine 10 moves to a region above or below the solid curve C1. A region above or below the solid curve Cl is a region where the pulsation correction value is determined and the flow rate detection value by the air flow sensor 21s is adapted. Therefore, the internal combustion engine 10 can be prevented from being operated in the regions R1 and R3 where the pulsation error cannot be corrected, and the internal combustion engine 10 can be controlled using the flow rate detection value of the air flow sensor 21s in which the pulsation error has been corrected. Therefore, according to the control method ECM for the internal combustion engine of the present embodiment, it is possible to prevent deterioration of the operation performance and the exhaust component of the internal combustion engine 10.

As illustrated in FIG. 8, the control method ECM for the internal combustion engine of the present embodiment includes a pulsation rate learning step PP1 and an allowable pulsation rate calibration step PP2 as the pre-step PP. The pulsation rate learning step PP1 is a step of learning the relationship between the control target value CTV and the pulsation rate under the reference condition of the internal combustion engine 10 to generate the pulsation rate map 131. The allowable pulsation rate calibration step PP2 is a step of generating the allowable pulsation rate map 141 based on the pulsation rate map 131.

With such a configuration, according to the control method ECM for the internal combustion engine of the present embodiment, the pulsation rate map 131 and the allowable pulsation rate map 141 used in the pulsation rate prediction step S1 and the allowable pulsation rate output step S2 described above can be generated by machine learning.

As described above, according to the present embodiment, it is possible to provide the control device 100 of the internal combustion engine and the control method ECM for the internal combustion engine capable of preventing the relationship between the rotation speed of the internal combustion engine 10 and the pulsation rate of the intake air from deviating from the range in which the pulsation correction value is determined and preventing the operation performance of the internal combustion engine 10 and the deterioration of the exhaust component.

### Second Embodiment

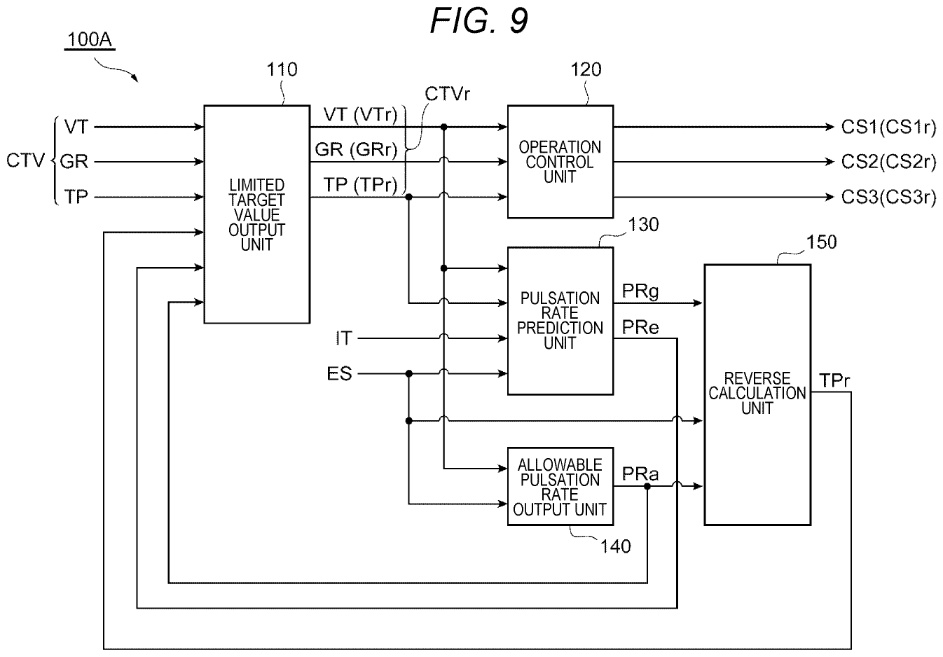

Hereinafter, a second embodiment of a control device of an internal combustion engine according to the present disclosure will be described with reference to FIG. 9 together with FIG. 1 and FIGS. 3 to 8 of the first embodiment described above. FIG. 9 is a block diagram illustrating an embodiment of the control device of the internal combustion engine according to the present disclosure and corresponding to FIG. 2 of the first embodiment.

A control device 100A of the internal combustion engine of the present embodiment is different from the control device 100 of the internal combustion engine of the first embodiment described above in further including a reverse calculation unit 150. Since other configurations of the control device 100A of the internal combustion engine of the present embodiment are similar to those of the control device 100 of the internal combustion engine of the first embodiment described above, the same reference numerals are given to the same parts, and the description thereof will be omitted.

The reverse calculation unit 150 illustrated in FIG. 9 outputs an allowable target value that is an allowable value of the control target value CTV of the internal combustion engine 10 based on the allowable pulsation rate PRa in a reverse procedure to that of the pulsation rate prediction unit 130. More specifically, for example, a maximum pulsation rate PRg output from the maximum pulsation rate map 131a of the pulsation rate prediction unit 130 illustrated in FIG. 3, the rotation speed ES of the internal combustion engine 10, and the allowable pulsation rate PRa output from the allowable pulsation rate output unit 140 are input to the reverse calculation unit 150 illustrated in FIG. 9.

The reverse calculation unit 150 includes, for example, a throttle opening reverse map (not illustrated). For example, an allowable pulsation rate ratio obtained by dividing the predicted pulsation rate PRe by the maximum pulsation rate PRg is input to the throttle opening reverse map, and a limited throttle opening TPr based on the allowable pulsation rate ratio and the rotation speed ES is output.

In other words, the reverse calculation unit 150 outputs the limited throttle opening TPr as an allowable target value which is an allowable value of the control target value CTV of the internal combustion engine 10 based on the maximum pulsation rate PRg according to the operation state of the internal combustion engine 10 in a reverse procedure to the pulsation rate prediction unit 130. The limited throttle opening TPr output from the reverse calculation unit 150 is input to the limited target value output unit 110. The limited target value output unit 110 outputs the limited throttle opening TPr as the allowable target value input from the reverse calculation unit 150 as the limited target value CTVr.

As described above, the control device 100A of the internal combustion engine of the present embodiment further includes the reverse calculation unit 150 in addition to each configuration of the control device 100 of the internal combustion engine of the first embodiment described above. The reverse calculation unit 150 outputs the limited throttle opening TPr as an allowable target value which is an allowable value of the control target value CTV of the internal combustion engine 10 in a reverse procedure to the pulsation rate prediction unit 130 based on the maximum pulsation rate PRg according to the operation state of the internal combustion engine 10. In addition, the limited target value output unit 110 outputs, as the limited target value CTVr, the limited throttle opening TPr as the allowable target value input from the reverse calculation unit 150.

With such a configuration, the control device 100A of the internal combustion engine of the present embodiment can output the limited throttle opening TPr by the reverse calculation unit 150 without repeatedly executing steps S1 to S7 illustrated in FIG. 4 unlike the control device 100 of the internal combustion engine of the first embodiment described above. As a result, the calculation load of the control device 100A of the internal combustion engine can be reduced.

Although the embodiments of the control device and the control method for the internal combustion engine according to the present disclosure have been described above, the control device and the control method for the internal combustion engine according to the present disclosure are not limited to the above-described embodiments. Addition, omission, substitution, and other changes of the configuration can be made without departing from the gist of the present disclosure.

### REFERENCE SIGNS LIST

10 internal combustion engine
11 intake valve
12 exhaust valve
20 intake flow path
21s air flow sensor
22c throttle valve
30 exhaust flow path
40 turbocharger
100 control device of internal combustion engine
100A control device of internal combustion engine
110 limited target value output unit
120 operation control unit
130 pulsation rate prediction unit
131 pulsation rate map
140 allowable pulsation rate output unit
141 allowable pulsation rate map
150 reverse calculation unit
CTV control target value
CTVr limited target value
ECM control method for internal combustion engine
ES rotation speed (operation state)
GR target gear ratio
GRr limited gear ratio
IT intake air temperature
PP1 pulsation rate learning step
PP2 allowable pulsation rate calibration step
PRa allowable pulsation rate
PRe predicted pulsation rate
PRg maximum pulsation rate
S1 pulsation rate prediction step
S2 allowable pulsation rate output step
S4 operation control step
S5 limited target value output step
S6 limited target value output step
S7 limited target value output step
TP target throttle opening
TPr limited throttle opening (allowable target value)
VT target valve timing
VTr limited valve timing

1. A control device of an internal combustion engine that controls the internal combustion engine using a flow rate detection value of an air flow sensor that detects an intake air amount of the internal combustion engine, the control device comprising:
an operation control unit that controls an operation state of the internal combustion engine based on a control target value of the internal combustion engine;
a pulsation rate prediction unit that outputs a predicted pulsation rate obtained by predicting a pulsation rate of the flow rate detection value based on the control target value;
an allowable pulsation rate output unit that outputs an allowable pulsation rate that is a maximum value of the allowable pulsation rate based on the operation state of the internal combustion engine; and
a limited target value output unit that outputs a limited target value obtained by changing the control target value so as to reduce the pulsation rate in a case where the predicted pulsation rate exceeds the allowable pulsation rate, wherein
the operation control unit controls the operation state of the internal combustion engine based on the limited target value in a case where the limited target value is input.

2. The control device of the internal combustion engine according to claim 1, wherein
the control target value includes a target throttle opening that is a target value of an opening of a throttle valve that controls the intake air amount, and
the limited target value includes a limited throttle opening obtained by reducing the target throttle opening.

3. The control device of the internal combustion engine according to claim 1, wherein
the control target value includes a target valve timing that is a target value of opening/closing timing of an intake valve and an exhaust valve of the internal combustion engine, and
the limited target value includes a limited valve timing for decreasing blowback from a combustion chamber to an intake flow path than the target valve timing in a compression step of the internal combustion engine.

4. The control device of the internal combustion engine according to claim 1, wherein
the control target value includes a target gear ratio of an automatic transmission of a vehicle on which the internal combustion engine is mounted, and
the limited target value includes a limited gear ratio obtained by increasing or decreasing the target gear ratio so as to decrease the predicted pulsation rate.

5. The control device of the internal combustion engine according to claim 1, wherein
the pulsation rate prediction unit outputs the predicted pulsation rate based on a rotation speed of the internal combustion engine and an intake air temperature in addition to the control target value including an opening of a throttle valve that controls the intake air amount.

6. The control device of the internal combustion engine according to claim 5, wherein
the pulsation rate prediction unit outputs the predicted pulsation rate based on the control target value including opening/closing timing of an intake valve and an exhaust valve of the internal combustion engine.

7. The control device of the internal combustion engine according to claim 5, wherein
the pulsation rate prediction unit outputs the predicted pulsation rate based on the control target value including a target supercharging pressure of a turbocharger provided in an exhaust flow path and an intake flow path of the internal combustion engine.

8. The control device of the internal combustion engine according to claim 1, wherein
the pulsation rate prediction unit outputs the predicted pulsation rate based on the limited target value in a case where the limited target value is input.

9. The control device of the internal combustion engine according to claim 1, further comprising
a reverse calculation unit that outputs an allowable target value that is an allowable value of the control target value of the internal combustion engine in a reverse procedure to the pulsation rate prediction unit based on a maximum pulsation rate according to the operation state of the internal combustion engine, wherein
the limited target value output unit outputs the allowable target value as the limited target value.

10. A control method for an internal combustion engine that controls the internal combustion engine using a flow rate detection value of an air flow sensor that detects an intake air amount of the internal combustion engine, the method comprising:
controlling an operation state of the internal combustion engine based on a control target value of the internal combustion engine;
outputting a predicted pulsation rate obtained by predicting the pulsation rate based on the control target value using a pulsation rate map in which a relationship between the control target value of the internal combustion engine and a pulsation rate of the flow rate detection value under a reference condition of a predetermined temperature range is defined;
outputting the allowable pulsation rate based on the operation state using an allowable pulsation rate map indicating P relationship between an operation state s of the internal combustion engine and an allowable pulsation rate which is a maximum value of the allowable pulsation rate; and
outputting a limited target value obtained by changing the control target value so as to reduce the pulsation rate in a case where the predicted pulsation rate exceeds the allowable pulsation rate, wherein
in the controlling, in a case where the limited target value is input, the operation state of the internal combustion engine is controlled based on the limited target value.

11. The control method of the internal i combustion engine according to claim 10, comprising:
learning a relationship between the control target value and the pulsation rate under the reference condition to generate the pulsation rate map; and
generating the allowable pulsation rate map based on the pulsation rate map.
